(19) United States
(12) Patent Application Publication
(10) Pub. No.: US 2008/0114539 A1
(43) Pub. Date: May 15, 2008

(54) DYNAMIC INTEGRATED LOCATION SERVICE SYSTEM AND METHOD, AND WIRELESS TERMINAL FOR SUPPORTING THE SYSTEM AND METHOD

(75) Inventor: Seung Phill LIM, Yongin-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NHN Corporation, Seongnam-si (KR)

(21) Appl. No.: 11/940,590

(22) Filed: Nov. 15, 2007

(30) Foreign Application Priority Data
Nov. 15, 2006 (KR) 10-2006-0112977

(51) Int. Cl. G01C 21/00; G01S 5/00; H04B 1/38

(52) U.S. Cl. 701/208; 455/73

(57) ABSTRACT

A dynamic integrated location service system and method for use in the system, and a wireless terminal for supporting the system and method are disclosed. The system receives location data from terminals having location data of different types, represents the received location data in the form of a single unified format, and simultaneously displays locations of the terminals on a map. The system includes a location-data processing server for receiving terminal's location data of at least one format, and a location-data integrating server for converting the terminal's location data of the at least one format into a single unified location data format including location information marked on a map.

### CROSS-REFERENCES TO RELATED APPLICATIONS

The present invention claims priority of Korean patent application number 2006-0112977, filed on Nov. 15, 2006, respectively, which are incorporated by reference in their entirety.

### BACKGROUND OF THE INVENTION

The present invention relates to a method for displaying location information of a terminal, and more particularly to a dynamic integrated location service system and method for receiving location data from terminals having location data of different types, representing the received location data in the form of a single unified format, and simultaneously displaying locations of the terminals on a map, and a terminal for supporting the system and method.

Recently, a variety of terminals, for example, a Global Positioning System (GPS) terminal, a mobile communication terminal, and a wireless Internet access terminal, have provided users with location indication services. The GPS terminal is used as a global positioning system based on an artificial satellite, receives radio frequency (RF) signals from the satellite recognizing accurate location information, and counts a time consumed to reach an observation point so that it can recognize the location of the observation point.

Generally, the GPS system measures a three-dimensional location of each terminal using at least four satellites so that it can recognize the location of the terminal.

There are a variety of GPS terminals, for example, a navigation terminal or a mobile communication terminal equipped with a GPS antenna. Location information measured by the GPS is represented by North Latitude 37°23′19″32 and East Longitude 127°3′3″21. The error of the location information is less than about 100 m.

A mobile communication terminal also provides a location confirmation service (also called a location decisions service) using the location of a base station or Node-B, or is planning to provide the same. The above-mentioned location decisions service is called a location based service (LBS). In a broad sense, the location display service based on the GPS may be considered to be one of the LBS services. In order to provide a mobile communication terminal having no GPS antenna with the LBS service, the mobile communication terminal communicates with mobile communication base stations (i.e., Node-Bs) so that it calculates relative location information associated with the Node-Bs using triangulation.

In the case of using the above-mentioned LBS service, if emergency situations occur, for example, if people are isolated in the mountains due to the flooding of the river or heavy rain, or if persons are confined in a room or building, each person may be able to inform the emergency rescue center of his or her correct location by pressing a small-sized button of his or her mobile communication terminal. The person can be rescued accordingly.

In yet another example, if a child is missing in a beach, the missing child's parents or a location service operator may be able to track the location of a bracelet worn on the wrist of the child so that the missing child can be found. Further, the physical distribution companies recognize current location information of their own vehicles in real time so that they can correctly recognize the physical distribution situations.

Also, the Internet terminal (i.e., the terminal capable of providing users with the Internet access) can also recognize its own location information. For example, if the Internet terminal has recognized a domain name or IP address of the terminal connected to the Internet, the terminal can recognize either an address of an organization to which a corresponding domain name or IP address is allocated, or an address where a computer or terminal is installed so that the location information of the Internet terminal can be recognized.

Conventionally, the location decision service for use in the GPS, LBS, or Internet terminal has been limited to specific devices capable of accessing the individual systems. In other words, the GPS terminal can receive location information from only the GPS system, and the LBS terminal can receive location information from only the LBS system. Likewise, the GPS or LBS terminal can recognize only its own location information using the location decision service, thus the GPS or LBS terminal is unable to recognize location information of other types of terminals.

Furthermore, the GPS system, the LBS system, and the Internet terminal, each use a different format for location data thus they are not interoperable with each other. As a result, the above-mentioned systems cannot display locations of terminals of different types on a single map using location data received from various sources, or cannot simultaneously display locations of several terminals on the single map.

### SUMMARY OF THE INVENTION

A dynamic integrated location service system is provided for receiving location data from terminals having location data of different types. The dynamic integrated location service system represents the received location data in the form of a single unified format, and simultaneously displays locations of the terminals on a map, and a method for use in the system.

In addition, a wireless terminal is provided for use in the dynamic integrated location service system, and a method is provided for displaying dynamic integrated location information on the wireless terminal.

In accordance with one aspect of the present invention, A dynamic integrated location service system comprises a location-data processing server for receiving terminal's location data of at least one format and a location-data integrating server for converting the terminal's location data of the at least one format into a single unified location data format including location information marked on a map.

In an aspect of the system, the location-data integrating server includes a location-data fabricating unit for fabricating the terminal's location data into predetermined location data corresponding to the map, a location-data converter for representing the fabricated location data in the form of a single unified language, and a service providing unit for combining the location data written by the unified language with map data, and providing the combined result. One of the preferred unified languages is an extensible markup language (XML).

The location data received in the location-data processing server includes at least one of GPS location data, LBS (Location-Based Service) location data, and Web data.

The location-data processing server includes at least one of a GPS-data processing server receiving the GPS location data, a LBS-data processing server receiving the LBS location data, and a Web-data processing server receiving the Web data.

In accordance with another aspect of the present invention, there is provided a dynamic integrated location service method. The method includes receiving terminal's location data of at least one format, and fabricating the received terminal's location data into specific location data corresponding to a map, and converting the fabricated location data into specific location data written by a single unified language, and providing the converted result.

In accordance with yet another aspect of the present invention, there is provided a wireless terminal for displaying dynamic integrated location information. The wireless terminal comprises a location-data transceiver for transmitting location data of a terminal, and for receiving first XML location data of the terminal and second XML location data of other terminals. The first XML location data is acquired when a map location corresponding to the terminal location data is converted into XML data. The wireless terminal further comprises a location-data processing unit for combining the received XML location data with map data, and for simultaneously displaying a location of the terminal and locations of the other terminals.

In accordance with yet another aspect of the present invention, there is provided a method for displaying dynamic integrated location information of a wireless terminal. The method includes transmitting location data of a terminal, receiving first XML location data of the terminal and second XML location data of other terminals and combining the received XML location data with map data, and simultaneously displaying a location of the terminal and locations of the other terminals. The first XML location data is acquired when a map location corresponding to the terminal location data is converted into XML data.

It is to be understood that both the foregoing general description and the following detailed description of the present invention are exemplary and explanatory and are intended to provide further explanation of the invention as claimed.

### BRIEF DESCRIPTION OF THE DRAWINGS

The foregoing aspects, other features and advantages of the present invention will become more apparent after reading the following detailed description when taken in conjunction with the drawings, in which:

FIG. 1 is a block diagram illustrating a dynamic integrated location service system according to one embodiment of the present invention;

FIGS. 2A and 2B are conceptual diagrams illustrating a method for converting a various types of location data into a single unified location data format according to one embodiment of the present invention;

FIG. 3 is a table illustrating a method for converting locations of several terminals into map locations according to one embodiment of the present invention;

FIG. 4 exemplarily shows XML location data according to one embodiment of the present invention;

FIG. 5 is a conceptual diagram illustrating map locations of terminals receiving different location services according to one embodiment of the present invention;

FIG. 6 is a flow chart illustrating a dynamic integrated location service method according to one embodiment of the present invention;

FIG. 7 is a block diagram illustrating a wireless terminal according to one embodiment of the present invention; and

FIG. 8 is a flow chart illustrating a method for displaying dynamic integrated location information of a wireless terminal according to one embodiment of the present invention.

### DETAILED DESCRIPTION

The following detailed description describes exemplary embodiments of the present invention. The exemplary embodiments will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

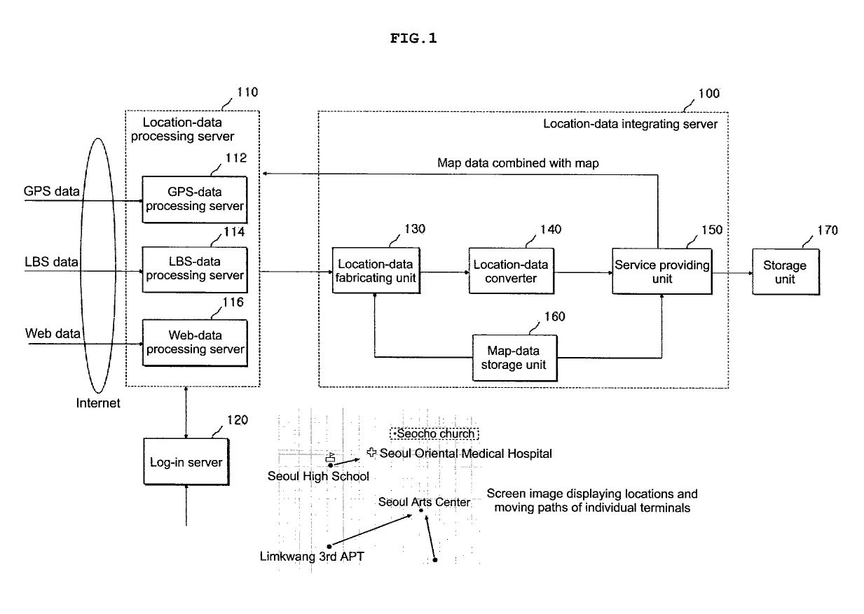

FIG. 1 is a block diagram illustrating a dynamic integrated location service system according to one embodiment of the present invention.

Referring to FIG. 1, the dynamic integrated location service system according to the present invention includes a location-data processing server 110, a log-in server 120, a location-data integrating server 100, and a storage unit 170. It should be noted that the log-in server 120 and the storage unit 170 may be optional.

In more detail, the location-data processing server 110 includes several location data processing servers, for example, a GPS-data processing server 112, a LBS-data processing server 114, a Web-data processing server 116, etc. The location-data integrating server 100 also includes a location-data fabricating unit 130, a location-data converter 140, a service providing unit 150, and a map-data storage unit 160.

The GPS terminal, the mobile communication terminal supporting the LBS service, and the Internet terminal recognize their own location data using different location decision systems, and transmit the recognized location data to the location-data processing server 110 over the Internet. Hereinafter, the mobile communication terminal supporting the LBS service is described as a LBS terminal.

In one embodiment, the location-data processing server 110 receives location data from the terminals of different types. In more detail, the GPS-data processing server 112 receives the GPS location data from a navigation terminal equipped with a GPS antenna or a mobile communication terminal. The LBS-data processing server 114 receives LBS data from the LBS terminal using the location or signal strength information of the Node-B. The Web-data processing server 116 receives Web-data-formatted location data from the Internet terminal to which the IP address is allocated.

The location-data integrating server 100 represents the received location data of different types in the form of a unified language (unified location data format), combines the location data represented in the unified language with map data, and provides the combined result.

In more detail, the location-data fabricating unit 130 fabricates the received terminal location data in the form of location data corresponding to a map. There are a variety of location data types, for example, X and Y coordinates represented by (X,Y).

In the case of the (X,Y) coordinates, the map is vertically and horizontally divided, and different X and Y coordinates are allocated to individual places. The location-data fabricating unit 130 generates an ID for identifying locations of individual places on the map using a specific ID of a location corresponding to the above-mentioned (X,Y) coordinates. For example, the point (X1,Y1) may be represented by “ID 100”, the point (X2,Y1) may be represented by “ID 101”, the point (X3,Y1) may be represented by “ID 102,” and so forth.

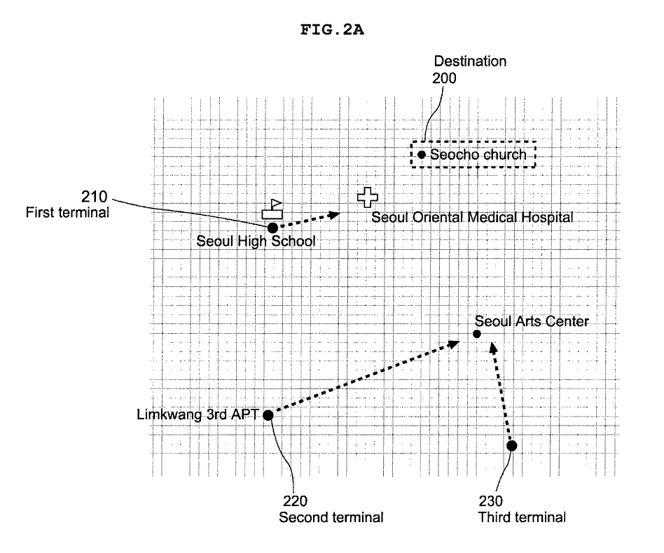

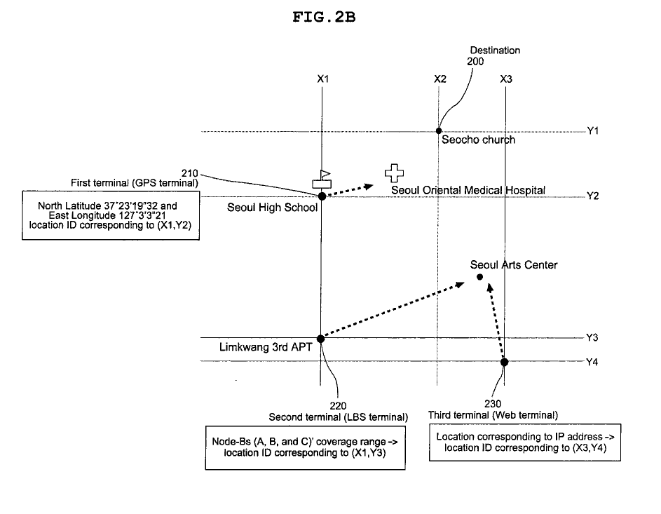

The method for generating location data corresponding to the map will hereinafter be described with reference to FIGS. 2A and 2B.

The location-data converter 140 represents the location data fabricated by the location-data fabricating unit 130 in the form of a unified language. The unified language may be any suitable language to commonly represent several types of location data. For example, the unified language may be an extensible markup language (XML). The unified language may be a hypertext markup language (HTML), or may also be any one of all markup languages which define tags and are represented by the tags.

The service providing unit 150 retrieves the converted location data, combines the retrieved location data with map data, and provides the combined result. The service providing unit 150 executes a variety of application programs, for example, a chatting program capable of simultaneously displaying locations of several users on the screen. In other words, if individual terminals gain access to the inventive service in the same manner as if the chatting program communicating with several users had checked up the states of the individual users, the individual terminals can dynamically check up the locations of other terminals.

Therefore, the service providing unit 150 combines at least one location data acquired by the above-mentioned operation with map data, and displays the combined result. If the converted location data is changed to another data due to the movement of the wireless terminal, the service providing unit 150 updates the location data on the map with new location data, and retransmits the updated result to the location-data processing server 110.

The map data storage unit 160 stores basic map data on which the location data is displayed. The map data may be configured in the form of map data used for general navigation terminals, etc.

The storage unit 170 stores the history of location information of the individual terminals. The storage unit 170 stores locations of individual terminals so that the stored location information may be used to search for the same or similar point in the future, or the moving path of each terminal may also be stored in the storage unit 170.

FIGS. 2A and 2B are conceptual diagrams illustrating a method for converting a variety of location data into single integrated location data according to one embodiment of the present invention.

FIG. 2A shows a method for generating integrated location data using three terminals, i.e., a first terminal 210, a second terminal 220, and a third terminal 230. For the purpose of discussion, assume that the first terminal 210, the second terminal 220, and the third terminal 230 are used to search for a destination 200 denoted by “Seocho Church” in FIG. 2A.

In this case, the first terminal 210, the second terminal 220, and the third terminal 230 may be implemented with any types of terminals, including but not limited to a GPS terminal, a LBS terminal, and an Internet terminal.

For the convenience of description and better understanding of the present invention, it is further assumed that the first terminal 210 is a GPS terminal, the second terminal 220 is a LBS terminal, and the third terminal 230 is an Internet terminal.

First of all, GPS location data, LBS location data, and Web-location data are received and converted into single unified location data. For this purpose, the map is divided into several sections spaced apart from each other by a predetermined distance as shown in FIG. 2A, and each intersection point is denoted by X and Y coordinates. Thus, the current locations and moving paths of the first to third terminals 210, 220, and 230 can also be denoted by X and Y coordinates on the map.

Referring to FIG. 2A, the first terminal 210 moves from a place “Seoul High School” to another place “Seoul Oriental Medical Hospital”, the second terminal 220 moves from “Limkwang 3rd APT” to “Seoul Arts Center”, and the third terminal 230 moves from the south area “Seoul Arts Center” to “Seoul Arts Center”. As illustrated, different X and Y coordinates are allocated to the first to third terminals 210, 220, and 230.

FIG. 2B shows a method for converting terminals' map location data acquired from the divided maps shown in FIG. 2A into single unified data.

Referring to FIG. 2B, the first terminal 210 is a GPS terminal that receives location data configured in the form of GPS data, and transmits the received location data to the GPS-data processing server 112. For example, this location data is represented by North Latitude 37°23′19″32 and East Longitude 127°3′3″21. If the above-mentioned location data is denoted by X and Y coordinates, (X1,Y2) is acquired. The location-data converter 140 converts the above-mentioned location data into an ID corresponding to each (X1,Y2) coordinates so that it outputs an ID corresponding to the (X1,Y2) coordinates.

As shown, the second terminal 220 is a LBS terminal. As will be well appreciated, if the GPS is not applied to the LBS terminal, the LBS terminal calculates location information associated with the distances from several Node-Bs using the Node-B location, the signal strength, and the triangulation. As can be seen from FIG. 2B, X and Y coordinates of the second terminal 220 are denoted by (X1,Y3). By conversion of the (X1,Y3) coordinates, a coordinate ID corresponding to the (X1,Y3) coordinates is acquired.

In FIG. 2B, the third terminal 230 is an Internet terminal (also called a Web terminal including an IP address). An IP addresses is allocated to each Internet terminal, and a coordinate ID of (X3,Y4) corresponding to the aforementioned IP address is acquired.

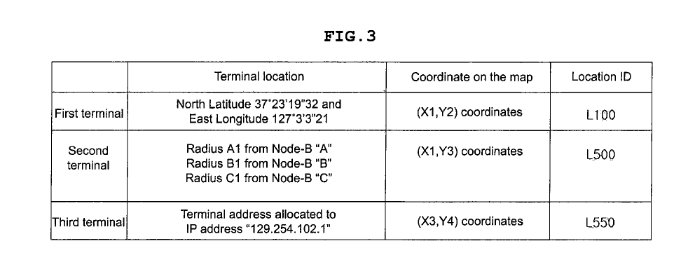

FIG. 3 is a table illustrating a method for converting locations of several terminals into map locations according to one embodiment of the present invention.

As described above, the first terminal 210 includes GPS location data. The location-data fabricating unit 130 converts the GPS location data represented by North Latitude 37°2′19″32 and East Longitude 127°3″3″21 into a location ID “L100” corresponding to the (X1,Y2) coordinates on the map.

The second terminal 220 includes LBS data. The location-data fabricating unit 130 converts location data, which corresponds to the radius A1 from the Node-B “A”, the radius B1 from the Node-B “B”, and the radius C1 from the Node-B “C”, into a location ID “L500” corresponding to the (X1,Y3) coordinates.

The third terminal 230 includes Web data e.g., an IP address. The location-data fabricating unit 130 converts a terminal address allocated to the IP address 129.254.102.1 into a location ID “L550” corresponding to the (X3,Y4) coordinates.

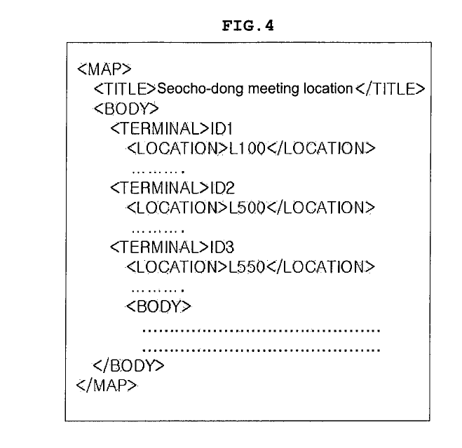

FIG. 4 shows exemplary XML location data according to one embodiment of the present invention.

As will be well appreciated, the XML is one of markup languages (e.g., HTML) using tags. Differently from the HTML, the XML uses extendable tags. The XML explains information, and distributes this information to a platform using an independent format. The XML guarantees the platform independence without using a specific language, and at the same time can construct a user-desired tag.

Referring to FIG. 4, the locations of the first terminal 210, the second terminal 220, and the third terminal 230 are described by the user-defined tags. In the case of using the XML, the user is able to define tags, the tags are not limited to the example of FIG. 4, and various kinds of tags capable of being interpreted by the user terminal can be used as the aforementioned tags of the present invention.

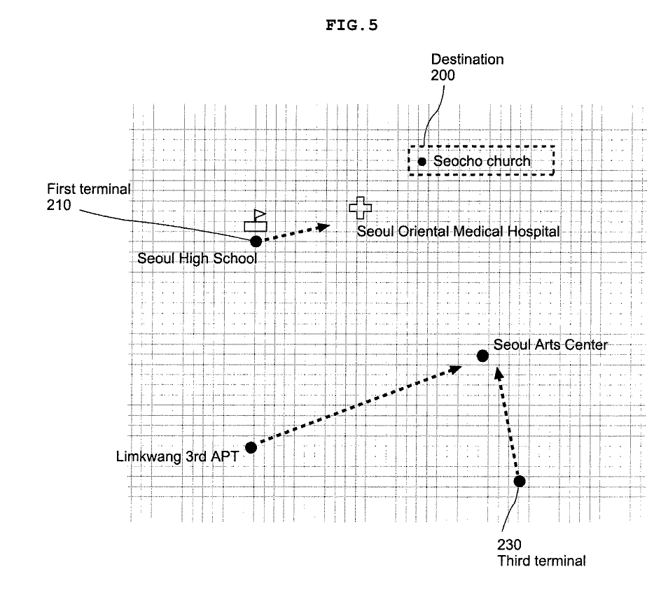

FIG. 5 is a conceptual diagram illustrating map locations of terminals receiving different location services according to one embodiment of the present invention.

Referring to FIG. 5, each terminal, including, but not limited to, the GPS terminal, the LBS terminal, and the Internet terminal, recognizes its location using a location decision system associated with the terminals, and transmits the recognized location data to the location-data processing server 110 over the Internet.

If each terminal desires to recognize the locations and moving paths of other terminals as well as its own location and moving path, it logs in the log-in server 120 to gain access to the location-date processing server 110 so that it receives corresponding data and then displays the received data. As can be seen from FIG. 5, not only the location and moving path of one terminal, but also the location and moving path information of other terminals may be displayed on a single map.

An exemplary application service based on the above-mentioned dynamic integrated location service system will hereinafter be described in detail.

For example, provided that several persons make a plan to depart from different start locations and then arrive at a single meeting place, they share their location and moving path information with each other so that one person may receive a road navigation service from other persons, and they may arrive at the meeting time at the same or similar time. For another example, although several persons depart from different places for the meeting place, they can mutually check their locations and can go to the meeting place at approximately same time.

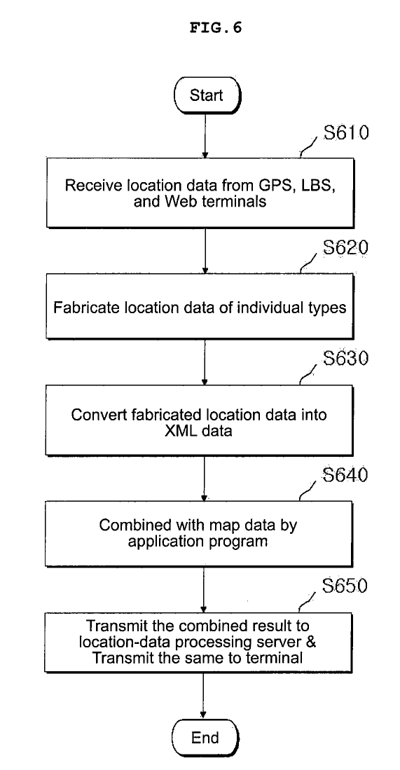

FIG. 6 is a flow chart illustrating a dynamic integrated location service method according to one embodiment of the present invention.

Referring to FIG. 6, the dynamic integrated location service system according to the present invention receives at least one location data of different types at step S610. For example, the dynamic integrated location service system receives a variety of location data from the GPS terminal, the LBS terminal, the Internet terminal, etc.

The above-mentioned system fabricates the location data for each data type at step S620. In other words, location data of different types is fabricated in the form of map location data corresponding to a map. The fabricating method of the location data has already been disclosed in FIGS. 2A and 2B. Thus, its detailed description will herein be omitted for the convenience of description.

Next, the fabricated location data is converted into XML data at step S630. The locations of the first to third terminals 210, 220, and 230 are represented by the user-defined tags, as shown in FIG. 4.

The XML location data is combined with map data provided by the service providing unit 150. If the service providing unit 150 executes an application program, location data of several terminals are combined with map data so that the combined result is displayed on the map at step S640. In this embodiment, if the terminals are in motion, the changed location data of the individual terminals is combined with the map data so that the service providing unit 150 provides the final result updated by the change in the location data.

Thereafter, the service providing unit 150 provides the location data combined with map data with the location-data processing server 110. If the terminal accesses the service via the log-in server 120, the system provides the terminal with the dynamic location information service at step S650.

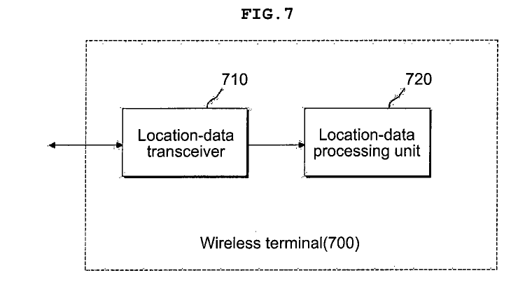

FIG. 7 is a block diagram illustrating a wireless terminal according to one embodiment of the present invention.

Although the wireless terminal 700 of FIG. 7 is depicted to include only a location-data transceiver 710 and a location-data processing unit 720 which are associated with the dynamic integrated location display service, the scope of the wireless terminal 700 is not limited to the above-mentioned example. It is contemplated that the wireless terminal 700 may further include other general components required for the wireless terminal functions as necessary.

The location-data transceiver 710 of FIG. 7 transmits location data of the wireless terminal 700, and receives XML location data of the terminal 700 and other terminals. In this case, the terminal 700's location data is acquired when a map location corresponding to the terminal 700's location data is converted into XML data.

The location-data processing unit 720 combines the received XML location data of the individual terminals with map data, and displays the combined result. The wireless terminal may be implemented with the GPS terminal, the LBS terminal, or the Internet terminal.

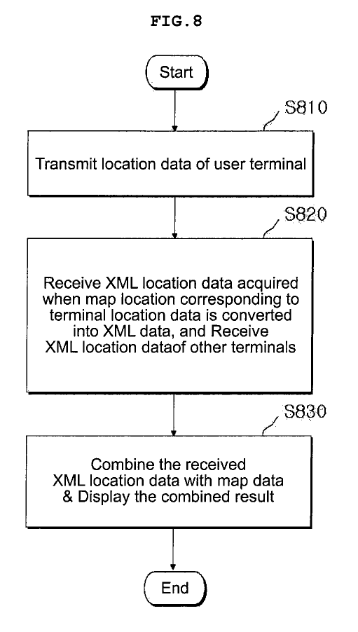

FIG. 8 is a flow chart illustrating a method for displaying dynamic integrated location information of a wireless terminal according to one embodiment of the present invention.

Referring to FIG. 8, the terminal 700 transmits its own location data at step S810. The terminal 700 receives XML location data acquired when a map location corresponding to the terminal 700's location data is converted into XML data, and also receives XML location data of other terminals at step S820. The method for expressing or converting the XML data has already been disclosed in detail above thus a detailed description thereof will herein be omitted for the convenience of description.

The received XML location data is combined with map data so that the combined result can be displayed on the terminal 700 at step S830. It is to be noted that not only the terminal 700's location information but also location information of other terminals can be displayed on a single map.

As will be appreciated by one of ordinary skill in the art, the above-mentioned dynamic integrated location service method can be implemented by a computer program. The codes or code-segments of this computer program can be easily estimated and recognized by computer programmers skilled in the art. In addition, the above-mentioned program is stored in a computer-readable medium so that it is read and executed by the computer, resulting in the implementation of the dynamic integrated location service method. The above-mentioned computer-readable medium may include various components such as a magnetic recording medium, an optical recording medium, and a carrier-wave medium.

It should be noted that most terminology disclosed in the present invention is defined in consideration of functions of the present invention, and can be differently determined according to intention of those skilled in the art or usual practices. Therefore, it is preferable that the above-mentioned terminology be understood on the basis of all contents disclosed in the present invention.

Although the embodiments of the invention have been disclosed above for illustrative purposes, those skilled in the art will appreciate that various modifications, additions and substitutions are possible, without departing from the scope and spirit of the invention as disclosed in the accompanying claims.

As apparent from the above description, the described and suggested embodiments of the present invention represents a location decision service which has been independently executed in different systems (i.e., the GPS location decision system, the LBS location decision system, and the WEB location decision system) using XML languages, and implements an integrated location decision service so that it can dynamically display locations of several terminals of different types on a single map.

In this way, the locations of individual terminals providing different location data can be displayed on the single map so that the location information of the individual systems which have not interacted with each other can be shared. In addition, several users who carry a variety of terminals can share location information on a single map so that the location information service can be greatly extended, resulting in the implementation of an ordered-type dynamic location information map. As a result, a new navigation service is provided.

What is claimed is:

1. A dynamic integrated location service system comprising:
a location-data processing server for receiving terminal's location data of at least two different formats; and
a location-data integrating server for converting the received terminal's location data of the at least two different formats into a unified location data format,
wherein the converted location data includes location information marked on a map.

2. The system according to claim 1, wherein the location-data integrating server includes:
a location-data fabricating unit for fabricating the received terminal's location data into predetermined location data corresponding to the map;
a location-data converter for representing the fabricated location data in the unified location data format; and
a service providing unit for combining the location data written in the unified location data form with map data to provide the combined result.

3. The system according to claim 2, wherein the location-data fabricating unit determines the terminal's location to be X and Y coordinates of the map, and converts the determined X and Y coordinates into an ID corresponding to the X and Y coordinates.

4. The system according to claim 3, wherein the predetermined location data is the ID corresponding to the X and Y coordinates of the terminal location.

5. The system according to claim 2, wherein the service providing unit dynamically updates the location data marked on the map with new data according to the movement of the terminal when the location data written in the unified location data format is combined with the map data and the location of the terminal is changed due to the movement of the terminal, and
wherein the service providing unit transmits the updated result to the location-data processing server after dynamically updating the location data marked on the map with the new data according to the movement of the terminal.

6. The system according to claim 2, wherein the location-data integrating server further includes a map-data storage unit for storing the map data.

7. The system according to claim 2, wherein the unified data format is a format of an extensible markup language (XML).

8. The system according to claim 1, wherein the location data received in the location-data processing server includes at least one selected from the group consisting of GPS location data, LBS (Location-Based Service) location data, and Internet location data.

9. The system according to claim 8, wherein the location-data processing server includes at least one selected from the group consisting of a GPS-data processing server receiving the GPS location data, a LBS-data processing server receiving the LBS location data, and a Web-data processing server receiving the Web data.

10. The system according to claim 1, further comprising:
a storage unit for storing history of location information of at least one terminal.

11. The system according to claim 2, wherein the unified data format is a format of a markup language which is represented by tags.

12. A dynamic integrated location service method comprising:
receiving terminal's location data in at least two different formats;
fabricating the received terminal's location data into predefined data corresponding to a map, wherein the predefined data relate to a location of the terminal on the map;
converting the fabricated location data into location data written in a unified language; and
providing the converted result.

13. The method according to claim 12, wherein the received terminal's location data includes at least one selected from the group consisting of GPS location data, LBS location data, and Web data.

14. The method according to claim 12, wherein the predefined data identify locations of places on the map using an identifier.

15. The method according to claim 12, wherein the unified language is an extensible markup language (XML).

16. The method according to claim 12, further comprising:
combining the location data written in the unified language with map data;
dynamically updating the combined result according to a change in the location data; and
providing the updated result.

17. A computer-readable recording medium having embodied thereon a program for performing the method of claim 12 in a computer.

18. A terminal for displaying dynamic integrated location information comprising:
a location-data transceiver for transmitting location data of a terminal, and for receiving first XML location data of the terminal and second XML location data of other terminals, wherein the first XML location data is acquired when a map location corresponding to the terminal location data is converted into XML data; and
a location-data processing unit for combining the first and second XML location data with map data respectively, and for simultaneously displaying a location of the terminal and locations of the other terminals.

19. The terminal according to claim 18, wherein the terminal includes at least one selected from the group consisting of a GPS terminal, a mobile communication terminal supporting a location-based service (LBS), and an Internet terminal capable of accessing the Internet.

20. A method for displaying dynamic integrated location information of a wireless terminal comprising:
transmitting location data of a terminal;
receiving first XML location data of the terminal and second XML location data of other terminals, wherein the first XML location data is generated when a map location corresponding to the terminal location data is converted into XML data;
combining the first and second XML location data with map data respectively; and
simultaneously displaying a location of the terminal and locations of the other terminals based on the combined location data.

21. The method according to claim 20, wherein the terminal and the other terminals include at least one selected from the group consisting of a GPS terminal, a mobile communication terminal supporting a location-based service (LBS), and an Internet terminal capable of accessing the Internet.
